(19) United States
(12) Patent Application Publication
(10) Pub. No.: US 2018/0357249 A1
(43) Pub. Date: Dec. 13, 2018

(54) INFORMATION DISPLAY DEVICE AND INFORMATION DISPLAY SYSTEM

(71) Applicant: TOYOTA JIDOSHA KABUSHIKI KAISHA, Toyota-shi (JP)

(72) Inventor: Koichi SUZUKI, Miyoshi-shi (JP)

(73) Assignee: TOYOTA JIDOSHA KABUSHIKI KAISHA, Toyota-shi (JP)

(21) Appl. No.: 16/000,036

(22) Filed: Jun. 5, 2018

(30) Foreign Application Priority Data
Jun. 12, 2017 (JP) 2017-115380

(51) Int. Cl. G06F 17/30; B60K 35/00

(52) U.S. Cl. CPC G06F 17/3087; B60K 2350/106; G06F 17/30991; B60K 35/00

(57) ABSTRACT

An information display system includes a search request receiver configured to receive a search request, a first acquisition unit configured to acquire first facility information searched from a first database based on the search request, a second acquisition unit configured to acquire second facility information searched from a second database based on the search request, and a display controller configured to cause the first facility information and the second facility information to be displayed in a distinguishable manner from each other.

### INCORPORATION BY REFERENCE

The disclosure of Japanese Patent Application No. 2017-115380 filed on Jun. 12, 2017 including the specification, drawings and abstract is incorporated herein by reference in its entirety.

### BACKGROUND

### 1. Technical Field

The present disclosure relates to an information display device and an information display system.

### 2. Description of Related Art

In the related art, an information providing device that can search a database for facility information (for example, a facility name, an address, a telephone number, a postal code, a keyword, and the like) conforming to a search condition input by a user, and can provide the facility information to the user is known. Among the information providing devices described above, there is an information providing device that can display a plurality of pieces of facility information searched from a plurality of databases on a display unit in a common form.

For example, Japanese Unexamined Patent Application Publication No. 2013-246469 (JP 2013-246469 A) discloses a technique in which a mobile terminal displays a list of registered facility information managed in a database stored in a storage unit of the mobile terminal and registered facility information managed in a database of an external content server on a display unit in a common form.

### SUMMARY

However, in the related art, in regard to each of a plurality of pieces of facility information displayed in the common form, the user cannot easily ascertain an acquisition source of the facility information. For this reason, for example, in the related art, in a case where the facility information of the same facility is searched from a plurality of databases, when the pieces of facility information is displayed on the display unit in the common form, the user may not determine facility information to be selected.

The present disclosure provides an information display device and an information display system that allows a user to easily ascertain an acquisition source of each of a plurality of pieces of facility information searched from a plurality of databases.

A first aspect of the present disclosure relates to an information display device including a search request transmitter, a first acquisition unit, a second acquisition unit, and a display controller. The search request transmitter is configured to transmit a search request to a first database and a second database. The first acquisition unit is configured to acquire first facility information searched from a first database based on the search request. The second acquisition unit is configured to acquire second facility information searched from a second database based on the search request. The display controller is configured to cause the first facility information and the second facility information to be displayed in a distinguishable manner from each other.

With this aspect, the first facility information and the second facility information are displayed in a distinguishable manner from each other. Accordingly, it is possible to allow a user to easily ascertain an acquisition source of each of the first facility information and the second facility information.

In the information display device according to the first aspect of the present disclosure, the second facility information may be facility information including at least a facility name and an address extracted from a document on a website. The display controller may cause the second facility information to be displayed such that the second facility information is identified to be facility information extracted from the document on the website.

With this aspect, the second facility information is displayed in a form capable of being identified to be the facility information extracted from the document on the website. Accordingly, it is possible to allow the user to easily ascertain that the second facility information is the facility information extracted from the document on the web site.

In the information display device according to the first aspect of the present disclosure, the display controller may cause display data of the second facility information to be displayed along with information representing the website related to the second facility information.

With this aspect, the second facility information is displayed along with information representing the related website. Accordingly, it is possible to allow the user to easily ascertain that the second facility information is the facility information extracted from the document on the website. In addition, it is possible to facilitate access to the related website and to allow the user to easily perform information acquisition from the web site.

In the information display device according to the first aspect of the present disclosure, the display controller may cause display data of the second facility information to be displayed along with a predetermined icon indicating the facility information extracted from the document on the website.

With this aspect, the second facility information is displayed along with the predetermined icon indicating the facility information extracted from the document on the website. Accordingly, it is possible to allow the user to easily ascertain that the second facility information is the facility information extracted from the document on the web site.

In the information display device according to the first aspect of the present disclosure, the display controller may cause the display data of the second facility information displayed in a list including the first facility information and the second facility information to be displayed along with the predetermined icon.

With this aspect, when the list including the first facility information and the second facility information is displayed, the predetermined icon is displayed with respect to the second facility information in the list. Accordingly, it is possible to allow the user to easily ascertain that the second facility information is the facility information extracted from the document on the web site in the list including the first facility information and the second facility information.

A second aspect of the present disclosure relates to an information display system including a search request transmitter, a search request receiver, a first search unit, a second search unit, a search result transmitter, a first acquisition unit, a second acquisition unit, and a display controller. The search request transmitter is configured to transmit a search request to an information providing device. The search request receiver is configured to receive the search request. The first search unit is configured to search first facility information from a first database based on the search request. The second search unit is configured to search second facility information from a second database based on the search request. The search result transmitter is configured to transmit a first search result searched by the first search unit and a second search result searched by the second search result. The first acquisition unit is configured to acquire the first search result from the search result transmitter. The second acquisition unit is configured to acquire the second search result from the search result transmitter. The display controller is configured to cause the first facility information acquired by the first acquisition unit and the second facility information acquired by the second acquisition unit to be displayed on an information display device in a distinguishable manner from each other.

With this aspect, the first facility information and the second facility information are displayed in a distinguishable manner from each other. Accordingly, it is possible to allow the user to easily ascertain the acquisition source of each of the first facility information and the second facility information.

According to the aspects of the present disclosure, it is possible to allow the user to easily ascertain the acquisition source of each of a plurality of pieces of facility information searched from a plurality of databases.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing the functional configuration of an information display system according to an embodiment;

FIG. 2 is a sequence diagram showing a procedure of processing by a center server and a vehicle device according to the embodiment;

FIG. 3 is a diagram showing a display example of a list of facility information by the vehicle device according to the embodiment; and

FIG. 4 is a diagram showing a display example of detailed information of facility information by the vehicle device according to the embodiment.

### DETAILED DESCRIPTION OF EMBODIMENTS

Hereinafter, an information display system according to an embodiment of the present disclosure will be described referring to the drawings.

Functional Configuration of Information Display System 10

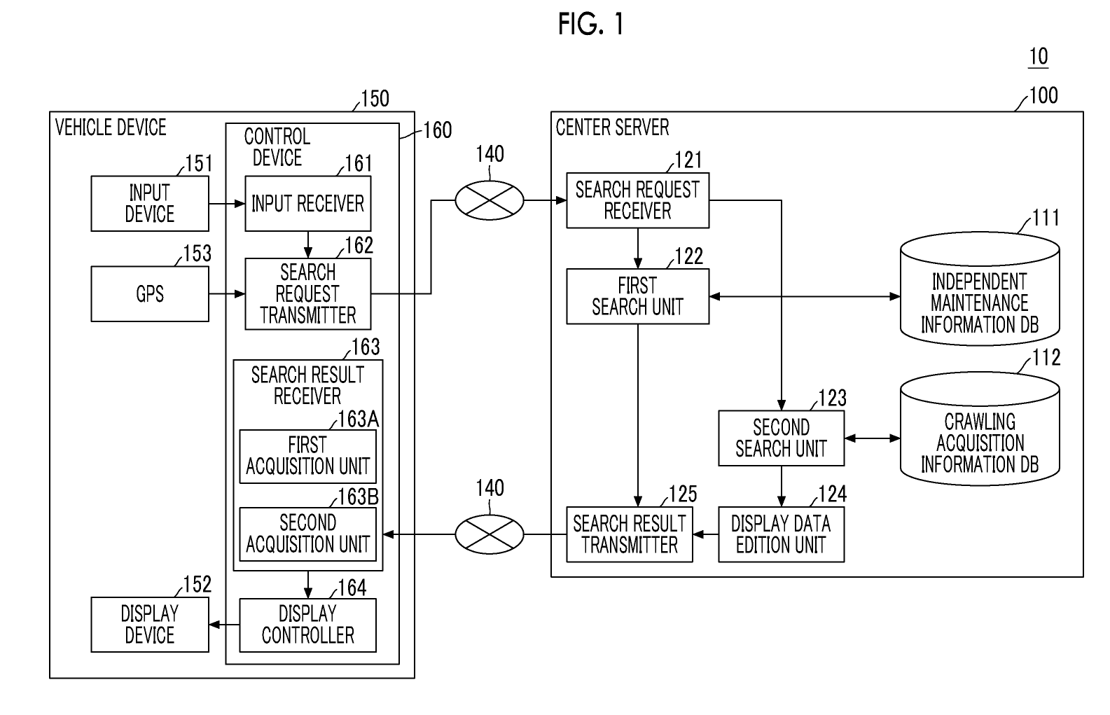

FIG. 1 is a diagram showing the functional configuration of an information display system 10 according to the embodiment. The information display system 10 shown in FIG. 1 includes a center server 100 and a vehicle device 150. The information display system 10 is a system in which information, such as facility information, can be provided from the center server 100 to the vehicle device 150 through a network 140. In FIG. 1, although the single vehicle device 150 is shown, the information display system 10 actually includes a plurality of vehicle devices 150 (all of these have the same configuration as the vehicle device 150 shown in FIG. 1). That is, the center server 100 can provide information to the vehicle devices 150.

The center server 100 is an example of an “information providing device”. The center server 100 is a device that is provided in a facility (for example, a facility that is managed by a company providing an information providing service) outside a vehicle. The center server 100 is connected to the network 140. As the network 140, for example, the Internet, a public wireless local area network (LAN) line, or the like is exemplified. The center server 100 can provide facility information to the vehicle device 150 through the network 140.

As shown in FIG. 1, the center server 100 includes an independent maintenance information DB 111, a crawling acquisition information DB 112, a search request receiver 121, a first search unit 122, a second search unit 123, a display data edition unit 124, and a search result transmitter 125.

The independent maintenance information DB 111 is an example of a “first database”. The independent maintenance information DB 111 stores a plurality of pieces of first facility information. The first facility information is facility information that is managed by the center server 100 itself. For example, the first facility information stored in the independent maintenance information DB 111 is provided from the outside by map software. The first facility information is fixed information that is hardly updated in a case when the first facility information is stored in the independent maintenance information DB 111.

The crawling acquisition information DB 112 is an example of a “second database”. The crawling acquisition information DB 112 stores a plurality of pieces of second facility information. The second facility information is facility information extracted from a document on a website. Specifically, the center server 100 extracts facility information from a document on a website on the Internet by performing known WEB crawling, and registers and updates the facility information to the crawling acquisition information DB 112. That is, even after the second facility information is stored in the crawling acquisition information DB 112, the second facility information is dynamic information that is extracted from a document on the website at regular intervals (for example, every day), and is registered or updated to the crawling acquisition information DB 112. Registration and update of the second facility information to the crawling acquisition information DB 112 may be performed by a device outside the center server 100.

The first facility information and the second facility information include a facility name, a genre, an address, a telephone number, a postal code, a keyword, positional information (latitude and longitude), detailed text information, an image, and the like. The second facility information further includes a uniform resource locator (URL) of a related website (for example, a website as an acquisition source of the facility information, a website of a facility corresponding to the facility information, or the like).

In a case where a search request of facility information is transmitted from the vehicle device 150, the search request receiver 121 receives the search request. The search request includes search conditions (for example, a genre, a name, a telephone number, an area, suitability of current location periphery search, and the like) of facility information received by the input receiver 161, a current position of a vehicle detected by a GPS 153, and the like.

In a case where the search request of the facility information is received by the search request receiver 121, the first search unit 122 searches the independent maintenance information DB 111 for first facility information conforming to the search conditions included in the search request.

In a case where the search request of the facility information is received by the search request receiver 121, the second search unit 123 searches the crawling acquisition information DB 112 for second facility information conforming to the search conditions included in the search request.

The display data edition unit 124 edits display data of at least one of the first facility information and the second facility information such that the first facility information searched from the independent maintenance information DB 111 by the first search unit 122 and the second facility information searched from the crawling acquisition information DB 112 by the second search unit 123 are displayed in a distinguishable manner from each other.

For example, the display data edition unit 124 includes a URL (an example of “information representing a website) of a website related to the second facility information in the display data of the second facility information. With this, when the second facility information is displayed in the vehicle device 150, the URL of the website related to the second facility information is displayed along with the second facility information. Accordingly, the user can easily identify that the second facility information is facility information extracted from a document on the website.

For example, the display data edition unit 124 includes a predetermined icon indicating facility information extracted from a document on the website in the display data of the second facility information. With this, when the second facility information is displayed in the vehicle device 150, the predetermined icon is displayed along with the second facility information. Accordingly, the user can easily identify that the second facility information is the facility information extracted from the document on the website.

The search result transmitter 125 transmits the first facility information searched from the independent maintenance information DB 111 by the first search unit 122 and the second facility information searched from the crawling acquisition information DB 112 by the second search unit 123 to the vehicle device 150 through the network 140. The search result transmitter 125 transmits the second facility information searched from the crawling acquisition information DB 112 by the second search unit 123 subjected to an edition of the display data by the display data edition unit 124.

The center server 100 includes hardware, such as a central processing unit (CPU), a main storage device (for example, a read only memory (ROM), a random access memory (RAM), and the like), and an auxiliary storage device (for example, a hard disk drive (HDD), a flash memory, or the like). Various functions of the center server 100 shown in FIG. 1 are realized by, for example, the CPU executing a program stored in the main storage device or the auxiliary storage device in the center server 100.

The center server 100 may be constituted of a single information processing device physically or may be constituted of a plurality of information processing devices physically. In the latter case, the information processing devices may be connected to one another through a network.

The vehicle device 150 is an example of an “information display device”. The vehicle device 150 is a device that is mounted in a vehicle, such as an automobile. The vehicle device 150 can receive facility information from the center server 100 through the network 140 and can display the facility information.

After a plurality of pieces of facility information is displayed, the vehicle device 150 can search for a route from a current position of the vehicle to a destination with a location of one piece of facility information selected among the pieces of facility information by a user as a destination and can perform route guidance using the route. That is, the vehicle device 150 has a function as a so-called navigation device. The route from the current position of the vehicle to the destination may be searched by the center server 100 and may be provided from center server 100 to the vehicle device 150.

As shown in FIG. 1, the vehicle device 150 includes, as devices related to search and display of facility information, an input device 151, a display device 152, a global positioning system (GPS) 153, and a control device 160.

The input device 151 is a device that is used when the user inputs various kinds of information (for example, search conditions of facility information, and the like). As the input device 151, for example, a touch panel, operation buttons, a cross key, a sound input device (microphone), and the like are exemplified. The display device 152 is a device that displays various kinds of information (for example, an input screen of search conditions, a search result of facility information, and the like). As the display device 152, for example, a liquid crystal display, an organic EL display, and the like are exemplified. The GPS 153 detects a current position (latitude and longitude) of the vehicle based on GPS signals received from GPS satellites.

The control device 160 is a device that controls processing on the display device 152 side in searching for and displaying facility information. As shown in FIG. 1, the control device 160 includes an input receiver 161, a search request transmitter 162, a search result receiver 163, and a display controller 164.

The input receiver 161 receives an input of search conditions of the facility information (for example, a genre, a name, a telephone number, an area, suitability of current location periphery search, and the like) by the input device 151.

The search request transmitter 162 transmits the search request of the facility information to the center server 100 through the network 140. The search request of the facility information includes the search conditions of the facility information received by the input receiver 161, the current position of the vehicle detected by the GPS 153, and the like.

In a case where a plurality of pieces of facility information is searched by the center server 100, the search result receiver 163 receives the pieces of facility information from the center server 100 through the network 140. The search result receiver 163 has a first acquisition unit 163A and a second acquisition unit 163B. The first acquisition unit 163A acquires first facility information searched from the independent maintenance information DB 111. The second acquisition unit 163B acquires second facility information searched from the crawling acquisition information DB 112.

The display controller 164 causes the pieces of facility information received by the search result receiver 163 to be displayed on the display device 152. For example, the display controller 164 causes a list of the pieces of facility information received by the search result receiver 163 to be displayed on the display device 152. For example, in a case where a predetermined piece of facility information is selected from the list displayed on the display device 152 using the input device 151, the display controller 164 causes detailed information of the predetermined piece of facility information to be displayed on the display device 152.

The display controller 164 causes the first facility information and the second facility information to be displayed in a distinguishable manner from each other. For example, the display controller 164 causes display data of the second facility information to be displayed along with a predetermined icon indicating facility information extracted from a document on a website. For example, the display controller 164 causes the display data of the second facility information to be displayed along with a URL of a website related to the second facility information. For example, the display controller 164 causes the display data of the second facility information displayed in the list to be displayed along with the predetermined icon the facility information extracted from the document on the website in displaying the list of the pieces of facility information.

The control device 160 includes hardware, such as a CPU, a main storage device (for example, a ROM, a RAM, or the like), and an auxiliary storage device (for example, an HDD, a flash memory, or the like). Various functions of the control device 160 shown in FIG. 1 are realized by, for example, the CPU executing a program stored in the main storage device or the auxiliary storage device in the control device 160.

Procedure of Processing by Center Server 100 and Vehicle Device 150

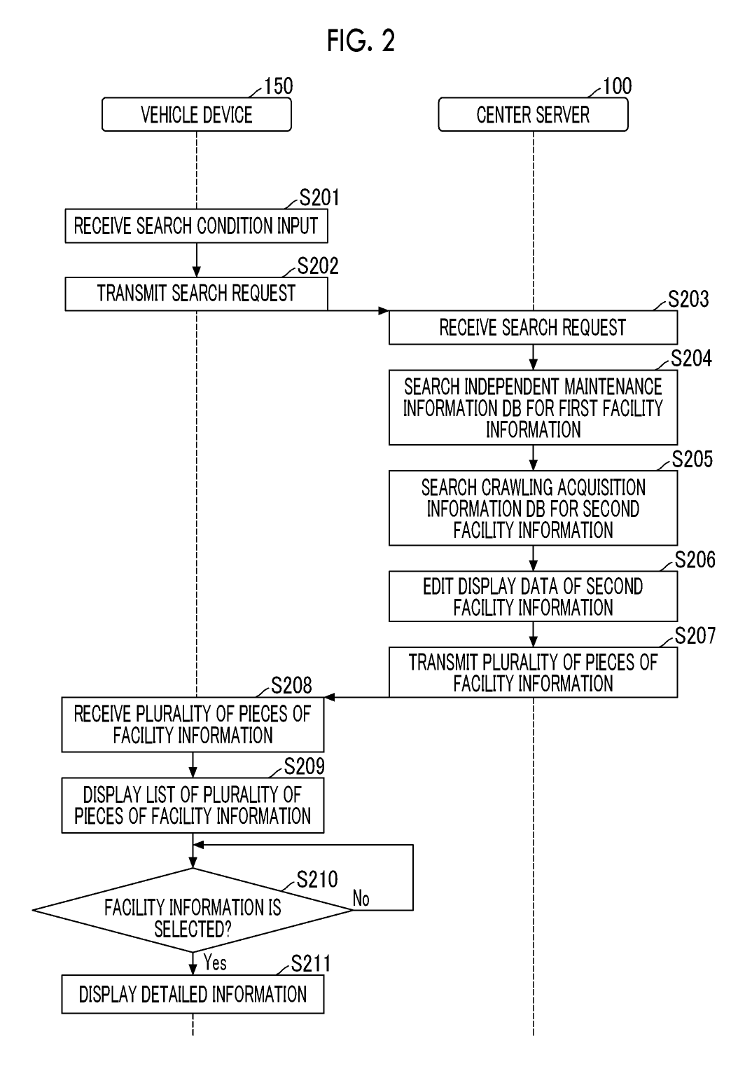

FIG. 2 is a sequence diagram showing a procedure of processing by the center server 100 and the vehicle device 150 according to the embodiment. The processing of FIG. 2 is started, for example, when a predetermined execution operation for starting search processing of facility information is performed from the user in the vehicle device 150.

First, in the vehicle device 150, the input receiver 161 receives the input of the search conditions of the facility information by the input device 151 (Step S201). Next, the search request transmitter 162 transmits the search request of the facility information to the center server 100 through the network 140 (Step S202). The search request of the facility information includes the search conditions and the like received in Step S201.

In the center server 100, the search request receiver 121 receives the search request transmitted in Step S202 (Step S203). Next, the first search unit 122 searches the independent maintenance information DB 111 for the first facility information conforming to the search conditions included in the search request received in Step S203 (Step S204).

The second search unit 123 searches the crawling acquisition information DB 112 for the second facility information conforming to the search conditions included in the search request received in Step S203 (Step S205). Then, the display data edition unit 124 edits the display data of the second facility information searched in Step S205 such that the first facility information searched in Step S204 and the second facility information searched in Step S205 are displayed in a distinguishable manner from each other (Step S206).

Subsequently, the search result transmitter 125 transmits a plurality of pieces of facility information including the first facility information searched in Step S204 and the second facility information with the display data edited in Step S206 to the vehicle device 150 through the network 140 (Step S207).

In the vehicle device 150, the search result receiver 163 receives the pieces of facility information transmitted in Step S207 (Step S208). Next, the display controller 164 causes a list of the pieces of facility information received in Step S208 to be displayed on the display device 152 (Step S209).

Subsequently, the display controller 164 determines whether or not one piece of facility information is selected from the list of the pieces of facility information displayed on the display device 152 in Step S209 (Step S210). In Step S210, in a case where determination is made that no facility information is selected (Step S210: No), the display controller 164 performs the determination processing of Step S210 again.

In Step S210, in a case where determination is made that one piece of facility information is selected (Step S210: Yes), the display controller 164 causes detailed information of the facility information selected in Step S210 to be displayed on the display device 152 (Step S211). Then, a sequence of processing shown in FIG. 2 ends.

Display Example of List of Facility Information

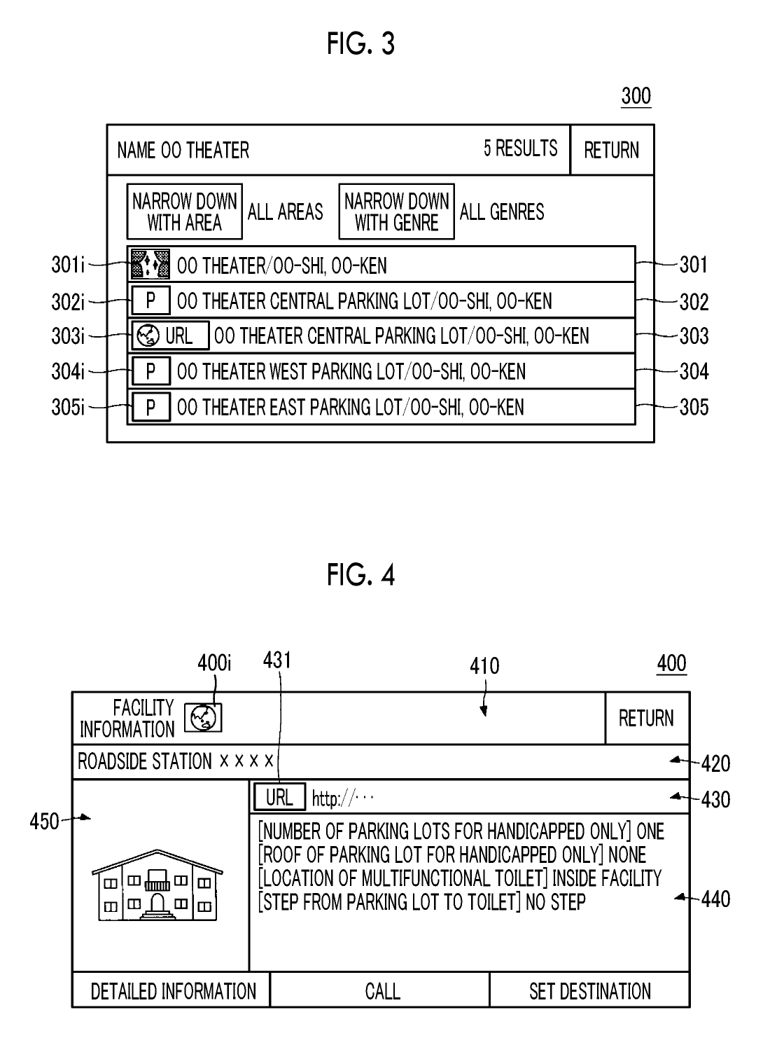

FIG. 3 is a diagram showing a display example of a list of facility information by the vehicle device 150 according to the embodiment. A display screen 300 shown in FIG. 3 is displayed on the display device 152 under the control of the display controller 164 in the vehicle device 150. The display screen 300 displays a list of a plurality of pieces of facility information searched by the center server 100.

For example, in the example shown in FIG. 3, five pieces of facility information 301 to 305 are displayed on the display screen 300 in the form of a list. The facility information 301 to 305 are searched by the center server 100 with a character string “OO theater” input in the vehicle device 150 as a search condition of a facility name. The facility information 301, 302, 304, 305 are first facility information searched from the independent maintenance information DB 111 by the first search unit 122. The facility information 303 is second facility information searched from the crawling acquisition information DB 112 by the second search unit 123.

On the display screen 300, in regards to the facility information 301 to 305, a facility name, an address, and icons 301i to 305i corresponding to the facility information are displayed as display data of the facility information 301 to 305. In regards to the facility information 301, 302, 304, 305 as the first facility information, the icons 301i, 302i, 304i, 305i corresponding to the genre of the facility information 301, 302, 304, 305 are displayed. In regard to the facility information 303 as the second facility information, the predetermined icon 303i representing second facility information extracted from a document on a website is displayed through the edition by the display data edition unit 124, instead of the icon corresponding to the genre of the facility information 303.

In the example shown in FIG. 3, the icon 303i includes an image of the earth and a character string “URL”. With the icon 303i, the user can easily visually ascertain that the facility information 303 is the second facility information extracted from the document on the website.

Display Example of Detailed Information of Facility Information

FIG. 4 is a diagram showing a display example of detailed information of facility information by the vehicle device 150 according to the embodiment. A display screen 400 shown in FIG. 4 is displayed on the display device 152 under the control of the display controller 164 in the vehicle device 150. The display screen 400 displays detailed information of one piece of facility information selected by the user among a plurality of pieces of facility information searched by the center server 100.

For example, in the example shown in FIG. 4, the display screen 400 has a title display field 410, a name display field 420, a URL display field 430, a detailed information display field 440, and an image display field 450. In the example shown in FIG. 4, facility information of a facility having a facility name “roadside station xxxx” is displayed by the display screen 400. The facility information is the second facility information searched from the crawling acquisition information DB 112 by the second search unit 123.

On the display screen 400, a character string “facility information” representing that the display screen 400 is a display screen of facility information is displayed in the title display field 410.

In the title display field 410, a predetermined icon 400i representing the facility information is the second facility information searched from the crawling acquisition information DB 112 is displayed. The icon 400i is included in an image of the earth reminding of the WEB. The icon 400i is included in the display data of the facility information by the display data edition unit 124. With the icon 400i, it is possible to allow the user to easily visually ascertain that the facility information is the second facility information extracted from the document on the website.

In the name display field 420, a facility name of the facility information is displayed. For example, in the example of FIG. 4, “roadside station xxxx” is displayed as the facility name of the facility information in the name display field 420.

In the URL display field 430, a URL of the website related to the facility information is displayed. The URL is included in the display data of the facility information by the display data edition unit 124. With the URL, it is possible to allow the user to easily visually ascertain that the facility information is the second facility information extracted from the document on the website.

In the URL display field 430, a push button 431 indicates as “URL” is displayed. The push button 431 is a button that is used to access the URL displayed in the URL display field 430. In a case where the push button 431 is pressed, the vehicle device 150 accesses the URL displayed in the URL display field 430 and displays a website specified by the URL.

In the detailed information display field 440, detailed text information of the facility information is displayed. For example, in the example of FIG. 4, detailed information relating to a parking lot and a toilet of a facility corresponding to the facility information is displayed in the detailed information display field 440 in the form of text.

In the image display field 450, a representative image of the facility corresponding to the facility information is displayed.

As described above, with the center server 100 according to the embodiment, the first facility information searched from the independent maintenance information DB 111 can be searched based on the search request received from the vehicle device 150. Along therewith, the second facility information can be searched from the crawling acquisition information DB 112, and the display data of the second facility information can be edited such that the first facility information and the second facility information are displayed in a distinguishable manner from each other in the vehicle device 150. With this, the first facility information and the second facility information are displayed in a distinguishable manner from each other in the vehicle device 150. Accordingly, it is possible to allow the user to easily ascertain the acquisition source of each of the first facility information and the second facility information.

In particular, with the center server 100 according to the embodiment, the display data of the second facility information can be edited such that the second facility information can be identified to be the facility information extracted from the document on the website. With this, the second facility information is displayed in a form of being identified to be the facility information extracted from the document on the website in the vehicle device 150. Accordingly, it is possible to allow the user to easily ascertain that the second facility information the facility information extracted from the document on the web site.

In addition, with the center server 100 according to the embodiment, the URL of the website related to the second facility information and the predetermined icon indicating the facility information extracted from the document on the website can be included in the display data of the second facility information. With this, the second facility information is displayed along with the URL of the related website and the predetermined icon indicating the facility information extracted from the document on the website in the vehicle device 150. Accordingly, it is possible to allow the user to easily ascertain the second facility information the facility information extracted from the document on the website. In addition, it is possible to facilitate access to the related website and to allow the user to easily perform information acquisition from the website.

Although the preferred embodiment of the present disclosure has been described above in detail, the present disclosure is not limited to the above-described embodiment, and various modifications or alterations may be made within the scope of the present disclosure described in the claims.

In the embodiment, although solely the display data of the second facility information is edited in order to display the first facility information and the second facility information in a distinguishable manner from each other, the present disclosure is not limited thereto. For example, both of the second facility information and the first facility information may be edited. For example, solely the first facility information may be edited.

In the embodiment, although a method of including the predetermined icon in the display data of the second facility information and a method of including the URL of the related website in the display data of the second facility information are used as an edition method of display data for displaying the first facility information and the second facility information in a distinguishable manner from each other, the present disclosure is not limited thereto. For example, a display color of the display data of the second facility information may be set to be different from a display color of the first facility information.

What is claimed is:

1. An information display device comprising:
a search request transmitter configured to transmit a search request to a first database and a second database;
a first acquisition unit configured to acquire first facility information searched from the first database based on the search request;
a second acquisition unit configured to acquire second facility information searched from the second database based on the search request; and
a display controller configured to cause the first facility information and the second facility information to be displayed in a distinguishable manner from each other.

2. The information display device according to claim 1, wherein:
the second facility information is facility information including at least a facility name and an address extracted from a document on a website; and
the display controller causes the second facility information to be displayed such that the second facility information is identified to be facility information extracted from the document on the website.

3. The information display device according to claim 2, wherein the display controller causes display data of the second facility information to be displayed along with information representing the website related to the second facility information.

4. The information display device according to claim 2, wherein the display controller causes display data of the second facility information to be displayed along with a predetermined icon indicating the facility information extracted from the document on the website.

5. The information display device according to claim 4, wherein the display controller causes the display data of the second facility information displayed in a list including the first facility information and the second facility information to be displayed along with the predetermined icon.

6. The information display device according to claim 1, wherein the information display device is mounted in a vehicle.

7. An information display system comprising:
a search request transmitter configured to transmit a search request to an information providing device;
a search request receiver configured to receive the search request;
a first search unit configured to search first facility information from a first database based on the search request;
a second search unit configured to search second facility information from a second database based on the search request;
a search result transmitter configured to transmit a first search result searched by the first search unit and a second search result searched by the second search unit;
a first acquisition unit configured to acquire the first search result from the search result transmitter;
a second acquisition unit configured to acquire the second search result from the search result transmitter; and
a display controller configured to cause the first facility information acquired by the first acquisition unit and the second facility information acquired by the second acquisition unit to be displayed on an information display device in a distinguishable manner from each other.

8. The information display system according to claim 7, wherein:
the information display device includes the search request transmitter, the first acquisition unit, the second acquisition unit and the display controller; and
the information providing device includes the search request receiver, the first search unit, the second search unit and the search result transmitter.

9. The information display system according to claim 8, wherein at least one of transmission of the search request to the information providing device and transmission of the first search result and the second search result to the information display device is performed through a network.

10. The information display system according to claim 7, wherein:
the information display device is mounted in a vehicle; and
the information providing device is provided in a facility outside a vehicle.
